(19) United States
(12) Patent Application Publication
(10) Pub. No.: US 2024/0338397 A1
(43) Pub. Date: Oct. 10, 2024

(54) METHODS AND APPARATUS TO DETERMINE A NUMBER OF DENOISING ITERATIONS FOR MODEL OUTPUT GENERATION

(71) Applicant: Intel Corporation, Santa Clara, CA (US)

(72) Inventors: Jean Xu Yu, Austin, TX (US); Haim Shmuel Barad, Zichron Yaakov (IL); Harsha Gupta, Sunnyvale, CA (US)

(21) Appl. No.: 18/745,711

(22) Filed: Jun. 17, 2024

(51) Int. Cl. G06F 16/33; G06F 40/279; G06T 11/00

(52) U.S. Cl. CPC G06F 16/3344; G06F 40/279; G06T 11/00

(57) ABSTRACT

Methods, apparatus, systems, and articles of manufacture to determine a number of denoising iterations of model output generation are disclosed. An example apparatus includes at least one programmable circuit to execute a model to generate a plurality of outputs based on a text-based prompt, each of the plurality of outputs generated using different numbers of denoising iterations; generate an ordered set of the plurality of outputs based on the number of denoising iterations; determine a plurality of similarities between neighboring outputs in the ordered set of the plurality of outputs; and select a number of denoising iterations based on the plurality of similarities.

### BACKGROUND

Diffusion models are artificial intelligence (AI)-based models that generate high-quality data by gradually adding noise to a dataset and then learning to reverse the process. The quality of the output of a diffusion model may depend on the number of iterations of adding noising and reversing the process.

### BRIEF DESCRIPTION OF THE DRAWINGS

FIG. 1 illustrates an example system including an example diffusion model that processes input prompts based on a target number of denoising iterations selected based on the input prompts.

FIG. 2 is an example implementation of the diffusion model of FIG. 1.

FIG. 3 is a block diagram of an example implementation of the training set generation circuitry of FIG. 1.

FIG. 4 is a block diagram of an example implementation of the iteration selection model training circuitry of FIG. 1.

FIG. 5 is a flowchart representative of example machine-readable instructions and/or operations that may be executed, instantiated, and/or performed by programmable circuitry to implement the training set generation circuitry of FIG. 3.

FIG. 6 is a flowchart representative of example machine-readable instructions and/or operations that may be executed, instantiated, and/or performed by programmable circuitry to implement the iteration selection model training circuitry of FIG. 4.

FIG. 7 is a flowchart representative of example machine-readable instructions and/or operations that may be executed, instantiated, and/or performed by programmable circuitry to implement the input redirector circuitry and/or the diffusion model of FIG. 2.

FIG. 8 is a block diagram of an example processing platform including programmable circuitry structured to execute, instantiate, and/or perform the example machine readable instructions and/or perform the example operations of FIGS. 5-6 to implement the training set generation circuitry and/riot the iteration selection model training circuit of FIGS. 3 and/or 4.

FIG. 9 is a block diagram of an example processing platform including programmable circuitry structured to execute, instantiate, and/or perform the example machine readable instructions and/or perform the example operations of FIG. 7 to implement the diffusion model of FIG. 2.

FIG. 10 is a block diagram of an example implementation of the programmable circuitry of FIGS. 8 and/or 9.

FIG. 11 is a block diagram of another example implementation of the programmable circuitry of FIGS. 8 and/or 9.

In general, the same reference numbers will be used throughout the drawing(s) and accompanying written description to refer to the same or like parts. The figures are not necessarily to scale.

### DETAILED DESCRIPTION

A diffusion model is a type of artificial intelligence (AI) (e.g., a deep neural network) based model that can generate images and/or other output media by transforming random noise (e.g., random numbers in a matrix or vector to represent a noisy image, video, sound, etc.) into visuals or other media in response to a prompt. A prompt is user-generated and/or machine-generate text that requests the generation or an output image or other media. A diffusion model performs a number of denoising iterations (e.g., denoising steps) to gradually denoise the random noise into the generated image. For example, during an inference phase (when generating new images), the diffusion model starts with a noise vector and iteratively denoises the noise vector to produce a clear image based on a number of denoising iterations.

Although diffusion models produce high quality images, diffusion models may be slow due to the number of denoising iterations. Although decreasing the number of denoising iterations will result in a fast diffusion model, fewer iterations may result in a poorer image quality output. Additionally, the time that it takes to generate an image from noise based on a prompt using popular AI image-generating platforms can vary significantly based on several factors, including the complexity of the prompt.

In operation, a diffusion model (e.g., a stable diffusion model) accepts textual input (e.g., a prompt) along with a seed. A seed is a numerical value that initializes the generation of an image. The textual input is processed through the contrastive language-image pretraining (CLIP) model to create a textual embedding of some particular dimensions (e.g., 77×768). The seed is utilized to generate Gaussian noise with particular dimensions (e.g., 4×64×64), which serves as the initial latent image representation. In some examples, a model (e.g., a U-Net model) denoises the random latent image representations using the text embeddings throughout the process. The model outputs a predicted noise residual, which a schedule algorithm employs to calculate conditioned latents.

This cycle of denoising and text conditioning is repeated N times (e.g., 50 iterations) to enhance the latent image representation. After completing this sequence, the latent image representation (e.g., a 4×64×64 image) is transformed by a variational autoencoder (VAE) decoder into the final output image (e.g., a 3×512×512 image).

The scheduler algorithm affects the quality of generated images by managing how much noise is introduced to the input image at each stage (e.g., iteration) of the denoising procedure, and then iteratively executing multiple operations to transform a noisy image into a clear one corresponding to the prompt. However, a conventional scheduler (e.g., pre-configured with N denoise iterations) corresponds to a performance bottleneck. For example, the number of denoising iterations determines the number of iterations the model takes to convert noise into an image. In some examples, a higher number of denoising iterations generally may lead to finer details and better quality in the resulting image but requires more computational resources and time.

Although the image quality generally increases as the number of denoising iterations increases, in some examples, a higher number of denoising iterations may lead to poorer details and/or worse results (i.e., at some point iterations may begin to add noise to the resulting image). For example, for a particular image prompt, the quality of an image may increase from 0-60 denoising iterations, but then the quality of the image may decrease after 60 denoising iterations. The number of denoising iterations that produce a good quality image may be different for different prompts. Examples disclosed herein include a model that can determine a target number of denoising iterations for a diffusion model based on a prompt so that the number of iterations balances image quality and resources. For example, examples disclosed herein determine, based on a prompt, the target number of denoising iterations that will result in a high-quality output with the lower number of denoising iterations, thereby increasing model output quality while reducing the amount of resources and time needed to generate an output. Accordingly, examples disclosed herein utilize the input prompt not only to generate an output, but also to determine how many denoising steps to apply when generating the output.

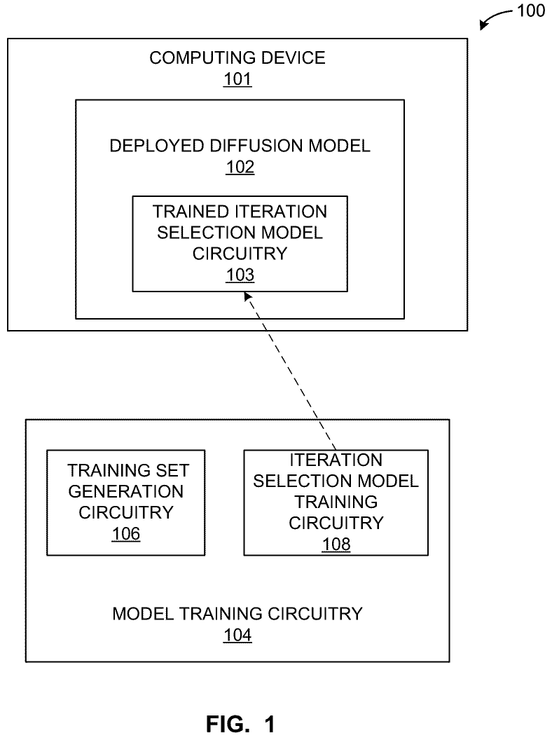

FIG. 1 illustrates an example system 100 including an example computing device 101 implementing an example deployed diffusion model 102 with a trained iteration selection model 103 to determine a target number of denoising iterations of model output generation. FIG. 1 further includes example model training circuitry 104 including training set generation circuitry 106 and iteration selection model training circuitry 108.

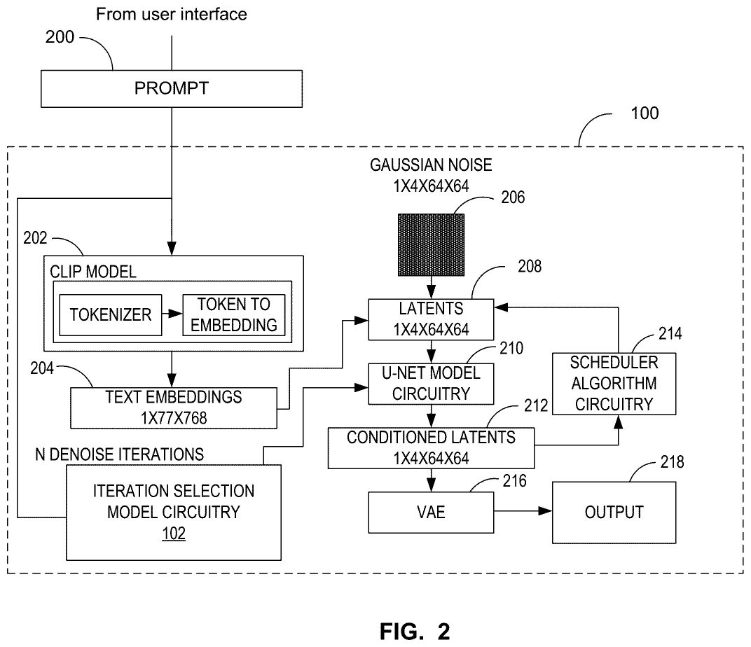

The computing device 101 implements a deployed diffusion model 102 that has been trained to generate an output based on an input prompt. Once trained, the deployed diffusion model 102 of FIG. 1 generates an output (e.g., an output image, output text, output video) based on any prompt. The prompt may be text that was generated by a user. For example, the user may, via a user interface of the computing device 101, generate a prompt to generate a design of a sneaker that incorporates Hawaiian flowers. The deployed diffusion model 102 receives the prompt and can generate an image, for example, which corresponds to the prompt. To generate the image, the deployed diffusion model 102 includes an input encoder (e.g., a CLIP model and/or an encoder), that generates an encoding (e.g., a numerical representation of the prompt that encapsulates the semantic information from the prompt) based on the input prompt. Additionally, a seed is used to generate Gaussian noise which becomes the first latent image representation of the output. The deployed diffusion model 102 includes a model (e.g., a U-Net model) that iteratively denoises the random latent image representations while conditioning on the text embeddings of the prompt. The model outputs a predicted noise residual, which is used to compute conditioned latents (e.g., compressed representations of the original data of an image) via a scheduler algorithm. The deployed diffusion model 102 performs the process of denoising and text conditioning N times to receive an output latent image representation. The trained iteration selection model 103 selects the N number of iterations, as further described below. After the N iterations, a VAE decoder of the deployed diffusion model 102 decodes the final latent image representation to generate an output. The deployed diffusion model 102 is further described below in conjunction with FIG. 2.

The trained iteration selection model 103 of FIG. 1 is a model that determines, during runtime of the deployed diffusion model 102, how many denoising iterations to apply when generating an output based on an input prompt. The trained iteration selection model 103 may be an AI-based model, such as a machine learning model, a deep learning model, a neural network, and/or any other AI-based model. The trained iteration selection model 103 implements a trained iteration selection model that was trained and deployed by the model training circuitry 104. After the target number of denoising iterations has been determined for an input prompt, the trained iteration selection model 103 outputs the number of iterations to the deployed diffusion model 102 so that deployed diffusion model 102 can perform the output generation protocol based on the number of determined denoising iterations.

The model training circuitry 104 of FIG. 1 trains and deploys the trained iteration selection model 103 that is used by the deployed diffusion model 102. The model training circuitry 104 includes the training set generation circuitry 106 to generate the training data used to train the iteration selection model and iteration selection model training circuitry 108 to train the iteration selection model using the training set generated by the training set generation circuitry 106.

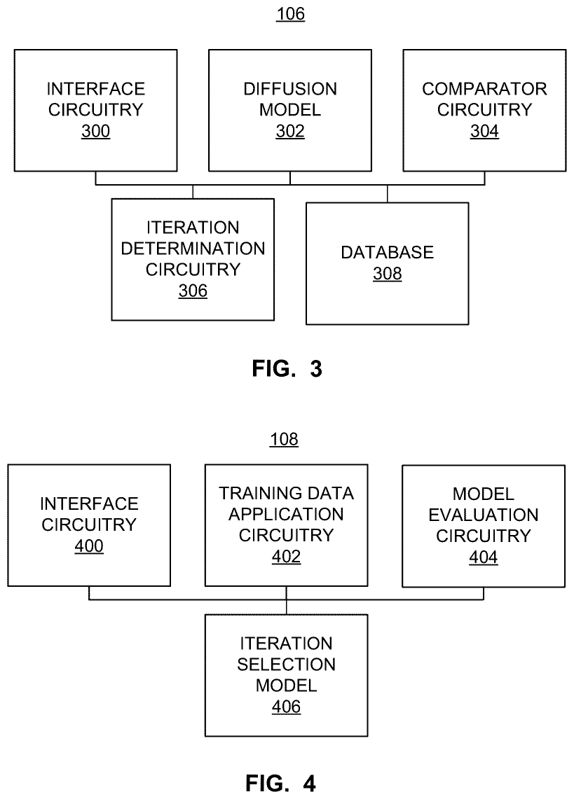

As described above, the training set generation circuitry 106 generates training data that is used to train an iteration selection model. The training data includes prompts correlated to (e.g., labelled with) a target number of denoising iterations. The target number of denoising iterations is selected to be a number of denoising iterations sufficient to generate a high-quality output based on the prompt. The training set generation circuitry 106 generates the training data by applying a prompt to one or more diffusion models that are structured to perform different numbers of denoising iterations. For example, the training set generation circuitry 106 may apply a prompt to a model to generate a first output based on 10 denoising iterations, apply the prompt to the model to generate a second output based on 20 denoising iterations, . . . , and apply the prompt to the model to generate a tenth output based on 100 denoising iterations. However, the number of outputs and/or the number of denoising iterations may be different based on user and/or manufacturer preferences. After the various outputs have been generated, the training set generation circuitry 106 compares the various output and selects a number of iterations based on the comparison(s). For example, the training set generation circuitry 106 determines a similarity (e.g., using a structural similarity index metric (SSIM)) between consecutive output images (e.g., the 10-iteration output to the 20-iteration output, the 20-iteration output to the 30-iteration output, the 30-iteration output to the 40-iteration output, etc.). The training set generation circuitry 106 selects the target number of denoising iterations based on when the similarity between two consecutive images decreases from the similarity between two previous consecutive images. A decrease in similarity between consecutive images implies that the diffusion model is beginning to delineate from the output generation and will likely result in a lesser quality output. The training set generation circuitry 106 stores a prompt in conjunction with the selected denoising iterations for the prompt as a portion of the training data. The training set generation circuitry 106 is further described below in conjunction with FIG. 3.

The iteration selection model training circuitry 108 of FIG. 1 trains an iteration selection model that is deployed to the deployed diffusion model 102 based on the training data generated by the training set generation circuitry 106. For example, the iteration selection model training circuitry 108 can train a model to generate a target number of denoising iterations to use in a diffusion process based on the prompt. The iteration selection model training circuitry 108 can train a deep learning model, a machine learning model, a neural network, and/or any other type of AI-based model. After the model has been trained, the iteration selection model training circuitry 108 deploys the trained model to the deployed diffusion model 102 and/or the device that implements the deployed diffusion model 102. In some examples, the iteration selection model training circuitry 108 can store the trained model(s) in an external database and/or server, and the deployed diffusion model 102 and/or the device that implements the deployed diffusion model 102 can obtain the trained model from the external database and/or server. The iteration selection model training circuitry 108 is further described below in conjunction with FIG. 4.

The model training circuitry 104 of FIG. 1 can communicate (e.g., transmit or receive data) with the deployed diffusion model 102 and/or a device that implements the deployed diffusion model 102 via a network communication (e.g., a wired and/or wireless connection).

FIG. 2 is a block diagram of an example implementation of the deployed diffusion model 102 of FIG. 1 to generate an output based on a prompt using a target number of denoising iterations selected based on the prompt. The deployed diffusion model 102 of FIG. 2 may be instantiated (e.g., creating an instance of, bring into being for any length of time, materialize, implement, etc.) by programmable circuitry such as a Central Processor Unit (CPU) executing first instructions. Additionally or alternatively, the deployed diffusion model 102 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers. FIG. 2 includes an example prompt 200, an example CLIP model circuitry 202, example text embeddings 204, example Gaussian Noise 206, example latents 208, example U-Net model circuitry 210, example conditioned latents 212, example scheduler algorithm circuitry 214, example VAE decoder circuitry 216, and an example output 218. The example deployed diffusion model 102 further includes the trained iteration selection model 103 of FIG. 1.

The prompt 200 of FIG. 2 is an input instruction from a user and/or other device. For example, the prompt 200 may be a text-based prompt obtained via a user interface, a microphone (e.g., converted to text), a keyboard, etc. connected to (e.g., via a wired or wireless network communication) the computing device 101. The prompt 200 may be an instruction to create a specific output. For example, the prompt 200 may be an instruction to generate an image of dogs playing poker done in the style of Fernando Botero. The prompt 200 is applied to the trained iteration selection model 103 and the CLIP model circuitry 202.

The trained iteration selection model 103 applied the prompt as an input and generates an output number (e.g., N) of denoising iterations based on the prompt. The trained iteration selection model 103 outputs the N denoising iterations to the U-NET model circuitry 210 to control the number of denoising iterations performed when generating the output 218, as further described below.

The CLIP model circuitry 202 of FIG. 2 is an encoder that takes the input prompt 200 and generates embeddings that are close in the latent space as it may be if you would have ended an image through a CLIP model. The CLIP model circuitry 202 may include tokenizer circuitry and token to embedding circuitry. The tokenizer circuitry breaks down each word into sub-words and converts the sub-words into a number (e.g., using a lookup table). The token to embedding circuitry converts the numbers into a representation (e.g., text embeddings) that includes a representation of the text. The CLIP model circuitry 202 outputs the text embeddings 204 to the U-NET model circuitry 210.

The Gaussian Noise 206 is a noisy image that is based on an input seed. The Gaussian Noise 206 is the first input latent representation (e.g., corresponding to the latents 208) that is input into the U-NET model circuitry 210. For example, when the deployed diffusion model 102 is structured to output images, the Gaussian noise 206 is a noisy image (e.g., an image where each pixel corresponds to a random number). After the first iteration, the latents 208 will correspond to an output of the scheduler algorithm circuitry 214. For example, the latents 208 may be a noisy version of an output image at a lower dimension than the ultimate output image.

The U-NET model circuitry 210 of FIG. 2 obtains the noisy latent 208 from the gaussian noise 206 and/or from the scheduler algorithm circuitry 214, the text embeddings 204 from the CLIP model circuitry 202, and the determined N number of denoise iterations from the trained iteration selection model 103. The U-NET model circuitry 210 predicts the noise (e.g., a predicted noise residual) which, when subtracted from the noisy latents 208, returns the noisy latents to the original de-noised latents. The U-NET model circuitry 210 may predict the noise based on the text embeddings 204. The U-NET model circuitry 210 applies the predicted noise to the noisy latent 208 to denoise the noisy latent 208. Accordingly, the U-NET model circuitry 210 iteratively denoises the random latest image representation (e.g., the latent 208) while conditioning on the text embeddings 204. The U-NET model circuitry 210 outputs a predicted noise residual that the U-NET model 210 uses to generate the conditioned latent 212. The conditioned latent 212 are compressed representations of the original data of an image being generated. The conditioned latent 212 is included in the input noisy latent 208 to the scheduler algorithm circuitry 214 for the first N−1 iterations. At the last Nth iteration, the U-NET model circuitry 210 outputs the final conditioned latents 212 to the VAE decoder circuitry 216.

The scheduler algorithm circuitry 214 of FIG. 2 obtains the conditioned latents 212 from the U-NET model circuitry 210. The scheduler algorithm circuitry 214 executes a scheduler algorithm to determine how much noise to add to the conditioned latent 212 at a particular iteration in the diffusion process. In some examples, the scheduler algorithm circuitry 214 initially adds high noise and gradually reduces the amount of noise with each subsequent iteration. The scheduler algorithm circuitry 214 outputs the latents 208, which corresponds to the conditioned latents 212 with noise added, to the U-NET model circuitry 210 for a subsequent iteration.

The VAE decoder circuitry 216 obtains the final conditioned latent 212 from the U-NET model circuitry 210 after the last iteration is complete. The VAE decoder circuitry 216 decodes the latent image representation corresponding to the conditioned latent 212 to output the final output image 218.

FIG. 3 is a block diagram of an example implementation of the training set generation circuitry 106 of FIG. 1 to generate training data to train an iteration selection model. The training set generation circuitry 106 of FIG. 3 may be instantiated (e.g., creating an instance of, bring into being for any length of time, materialize, implement, etc.) by programmable circuitry such as a Central Processor Unit (CPU) executing first instructions. Additionally or alternatively, the training set generation circuitry 106 of FIG. 3 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 3 may, thus, be instantiated at the same or different times. Some or all of the circuitry of FIG. 3 may be instantiated, for example, in one or more threads executing concurrently on hardware and/or in series on hardware. Moreover, in some examples, some or all of the circuitry of FIG. 3 may be implemented by microprocessor circuitry executing instructions and/or FPGA circuitry performing operations to implement one or more virtual machines and/or containers. The training set generation circuitry 106 of FIG. 3 includes example interface circuitry 300, an example diffusion model 302, example comparator circuitry 304, example iteration determination circuitry 306, and an example database 308.

The example interface circuitry 300 of FIG. 3 obtains prompts from a user (e.g., via a user interface) and/or machine-generated prompts. The interface circuitry 300 applies the prompts to the diffusion model 302 of FIG. 2.

The diffusion model 302 of FIG. 3 is a model trained to generate an output (e.g., an output image, an output video, etc.) based on an input prompt. The diffusion model 302 is structured to generate multiple outputs for different amounts of denoising iterations. For example, the diffusion model 302 may output a generated output after 10 denoising iterations, 20 denoising iterations, 30 denoising iterations, etc. all the way up to 100 denoising iterations. However, the number and increment of denoising iterations that correspond to an amount could be any number. In some examples, the diffusion model 302 may include multiple diffusion models (e.g., one diffusion model for each predetermined number of denoising iterations). The diffusion model 302 outputs the multiple outputs corresponding to multiple different denoising iterations to the example comparator circuitry 304.

The comparator circuitry 304 of FIG. 3 compares (e.g., determines a similarity between) the outputs of the diffusion model 302 in sequential order. For example, if the diffusion model 302 generated 10 outputs (e.g., a first output for 10 denoising iterations, a second output for 20 denoising iterations, . . . , and a tenth output for 100 denoising iterations), the comparator circuitry 304 determines a first similarity metric (e.g., a SSIM) between the first output and the second output, a second similarity metric between the second output and the third output, a third similarity metric between the third output and the fourth output, . . . and a ninth similarity metric between the ninth output and the tenth output. In such an example, output similarity metrics of the comparator circuitry 304 may be {0.5262, 0.6557, 0.6589, 0.6769, 0.4103, 0.3985, 0.3078, 0.4132, 0.3527}, where 0.5262 is the first similarity metric between the first and second outputs, 0.6557 is the second similarity metric between the second and third outputs, etc. The similarity metric may be a value between 0 and 1, where the higher the number the more similar the outputs are. The comparator circuitry 304 outputs the comparisons to the iteration determination circuitry 306.

The iteration determination circuitry 306 of FIG. 1 obtains the output comparisons from the comparator circuitry 304 and selects one of the target number of denoising iterations based on the comparisons. For example, the iteration determination circuitry 306 orders the comparison metric in order according to denoising iterations (e.g., the comparison of the lowest denoising iterations to the second lowest denoising iterations first and the comparison of the second highest denoising iterations to the highest denoising iterations last). The iteration determination circuitry 306 then determines the first comparison metric that is lower in similarity to a pervious comparison corresponding to lower denoising iterations, which corresponds to the first decrease in similarity when increasing denoising iterations. Using the above example, the iteration determination circuitry 306 orders the nine-similarity metrics {0.5262, 0.6557, 0.6589, 0.6769, 0.4103, 0.3985, 0.3078, 0.4132, 0.35271} for an example prompt. The iteration determination circuitry 306 then determines that the similarity between subsequent (e.g., neighboring) outputs increases for the first few comparisons (e.g., 0.5262 to 0.6769) before the similarity decreases (e.g., from 0.6769 to 0.4103). The iteration determination circuitry 306 determines that because the similarity decreases from 50 iterations to 60 iterations, the rate of improvement has slowed down. Accordingly, the iteration determination circuitry 306 selects the lowest denoising iterations between the two outputs that resulted in the first decline in similarity. Thus, in the above example, the iteration determination circuitry 306 selects 50 denoising iterations for the example prompt. The iteration determination circuitry 306 stores the prompt labelled with the selected denoising iterations in the database 308 to be used as training data to train an iteration selection model.

The database 308 of FIG. 3 stores the training data. As described above, the training data corresponds to example prompts labelled with corresponding selected denoising iterations that have been selected by the iteration determination circuitry 306 based on the prompt being applied to the diffusion model 302. The database 308 could be a datastore, memory, and/or any other type of storage.

FIG. 4 is a block diagram of an example implementation of the iteration selection model training circuitry 108 of FIG. 1 to train an iteration selection model. The iteration selection model training circuitry 108 of FIG. 4 may be instantiated (e.g., creating an instance of, bring into being for any length of time, materialize, implement, etc.) by programmable circuitry such as a Central Processor Unit (CPU) executing first instructions. Additionally or alternatively, the iteration selection model training circuitry 108 of FIG. 4 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 4 may, thus, be instantiated at the same or different times. Some or all of the circuitry of FIG. 4 may be instantiated, for example, in one or more threads executing concurrently on hardware and/or in series on hardware. Moreover, in some examples, some or all of the circuitry of FIG. 4 may be implemented by microprocessor circuitry executing instructions and/or FPGA circuitry performing operations to implement one or more virtual machines and/or containers. The training set generation circuitry 106 of FIG. 4 includes example interface circuitry 400, example training data application circuitry 402, example model evaluation circuitry 404, and an example iteration selection model 406.

The example interface circuitry 400 of FIG. 4 obtains training data from the database 308 of FIG. 3. Additionally, the example interface circuitry 400 can send information (e.g., model configuration, model weights, model thresholds, etc.) related to a trained iteration selection model to other components of the model training circuitry 104. For example, the interface circuitry 400 can send the model information to storage of the model training circuitry 104 to be stored locally and/or can send the model information to network interface circuitry of the model training circuitry 104 to send the model information to the computing device 101 (e.g., to implement the trained iteration selection model circuitry 103) using a network communication.

The training data application circuitry 402 of FIG. 4 applies a first portion of the training data to the iteration selection model 406 to train the iteration selection model 406. For example, the prompts and corresponding denoising iterations from the first portion of the training data may be used to adjust the weights and/or thresholds of the iteration selection model 406 using backpropagation. If after a first round of training, the model evaluation circuitry 404 determines that the accuracy of the iteration selection model 406 is below a threshold, the training data application circuitry 402 applies a second portion of the training data to further train and/or tune the iteration selection model 406 to increase the accuracy of the model.

The model evaluation circuitry 404 of FIG. 4 evaluates the iteration selection model 406 after each portion of the training data has been used to train the iteration selection model 406. For example, after a first iteration, the model evaluation circuitry 404 uses a portion of the training data that hasn't been used to train the iteration selection model 406 to test the accuracy of the iteration selection model 406. The model evaluation circuitry 404 can apply a prompt from the training data to the iteration selection model 406 and compare the output of the model to the target number of denoising iterations labelled in the training data. If the output of the model matches the labelled denoising iterations, the model evaluation circuitry 404 determines that the iteration selection model 406 correctly classified the input. Otherwise, the model evaluation circuitry 404 determines that the iteration selection model 406 incorrectly classified the input. The model evaluation circuitry 404 determines the accuracy of the iteration selection model 406 based on the number of correct and/or incorrect classifications. If the model evaluation circuitry 404 determines that the accuracy of the iteration selection model 406 is above a threshold, the model evaluation circuitry 404 outputs the model information for implementing the trained model to storage or to an external device via the interface circuitry 400. If the model evaluation circuitry 404 determines that the accuracy of the iteration selection model 406 is below a threshold, the model evaluation circuitry 404 instructs the training data application circuitry 402 to continue to train and/or tune the iteration selection model 406.

The iteration selection model 406 of FIG. 4 is initially an untrained model. The iteration selection model 406 may be a machine learning model, a deep learning model, a neural network, and/or any other type of AI-based model. As described above, the training data application circuitry 402 applies training data to the iteration selection model 406 to train the iteration selection model 406 to output a target number of denoising iterations based on an input prompt.

While an example manner of implementing the deployed diffusion model 102, the training set generation circuitry 106, and the iteration selection model training circuitry 108 of FIG. 1 is illustrated in FIGS. 2-4, one or more of the elements, processes, and/or devices illustrated in FIGS. 2-4 may be combined, divided, re-arranged, omitted, eliminated, and/or implemented in any other way. Further, the trained iteration selection model 103, the CLIP model circuitry 202, the U-NET model circuitry 210, the scheduler algorithm circuitry 214, the VAE decoder circuitry 216, the interface circuitry 300, the diffusion model 302, the comparator circuitry 304, the iteration determination circuitry 306, the database 308, the interface circuitry 400, the training data application circuitry 402, the model evaluation circuitry 404, the iteration selection model 406, and/or, more generally, the deployed diffusion model 102, the training set generation circuitry 106, and/or the iteration selection model training circuitry 108 of FIGS. 1-4, may be implemented by hardware alone or by hardware in combination with software and/or firmware. Thus, for example, any of the trained iteration selection model 103, the CLIP model circuitry 202, the U-NET model circuitry 210, the scheduler algorithm circuitry 214, the VAE decoder circuitry 216, the interface circuitry 300, the diffusion model 302, the comparator circuitry 304, the iteration determination circuitry 306, the database 308, the interface circuitry 400, the training data application circuitry 402, the model evaluation circuitry 404, the iteration selection model 406, and/or, more generally, the deployed diffusion model 102, the training set generation circuitry 106, and/or the iteration selection model training circuitry 108 of FIGS. 1-4, could be implemented by programmable circuitry in combination with machine-readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the deployed diffusion model 102, the training set generation circuitry 106 and the iteration selection model training circuitry 108 of FIGS. 1-4 may include one or more elements, processes, and/or devices in addition to, or instead of, those illustrated in FIGS. 1-4, and/or may include more than one of any or all of the illustrated elements, processes, and devices.

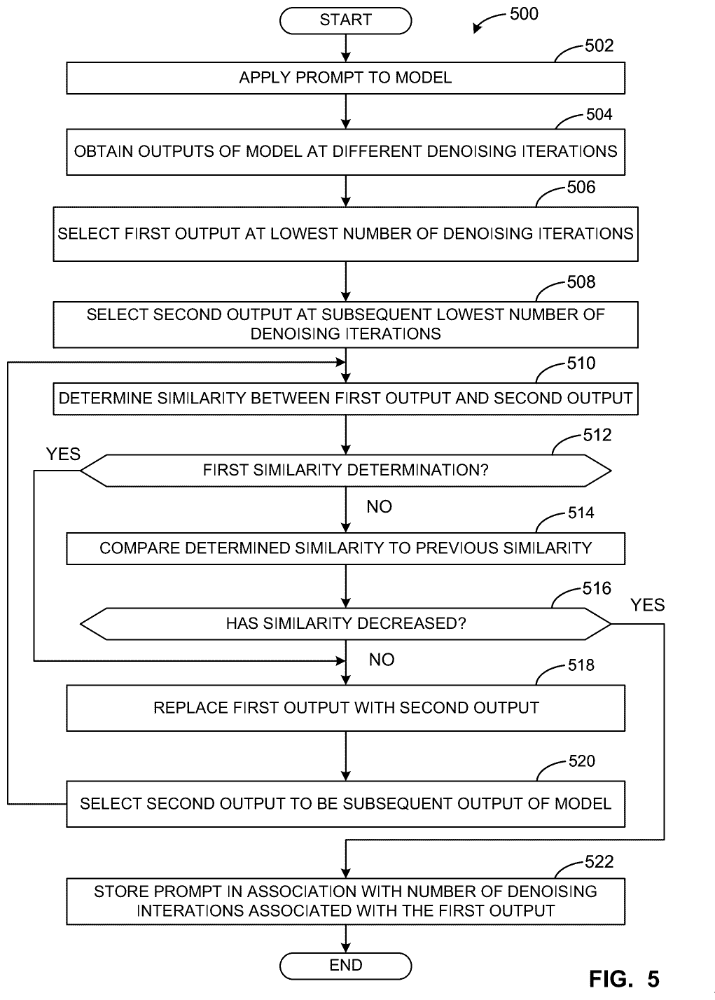

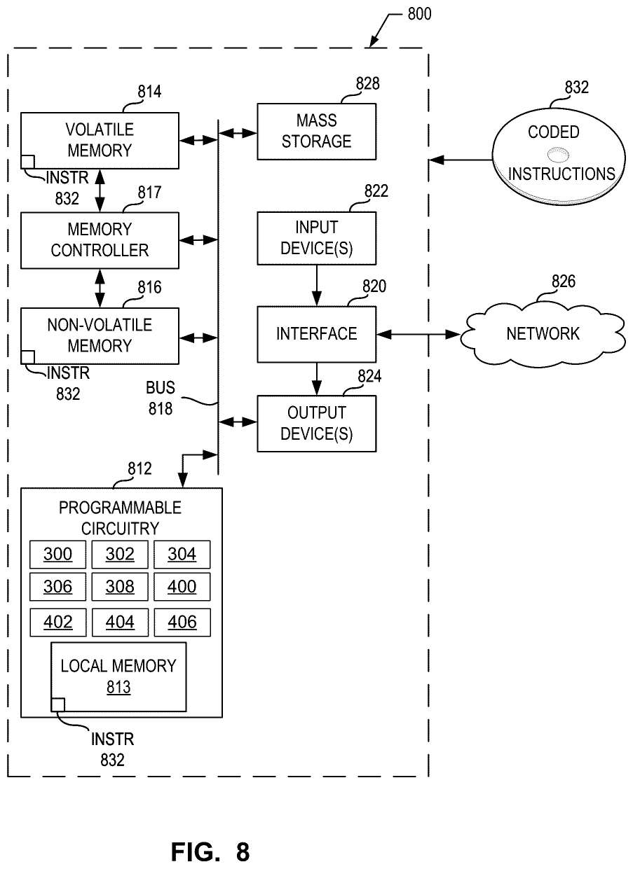

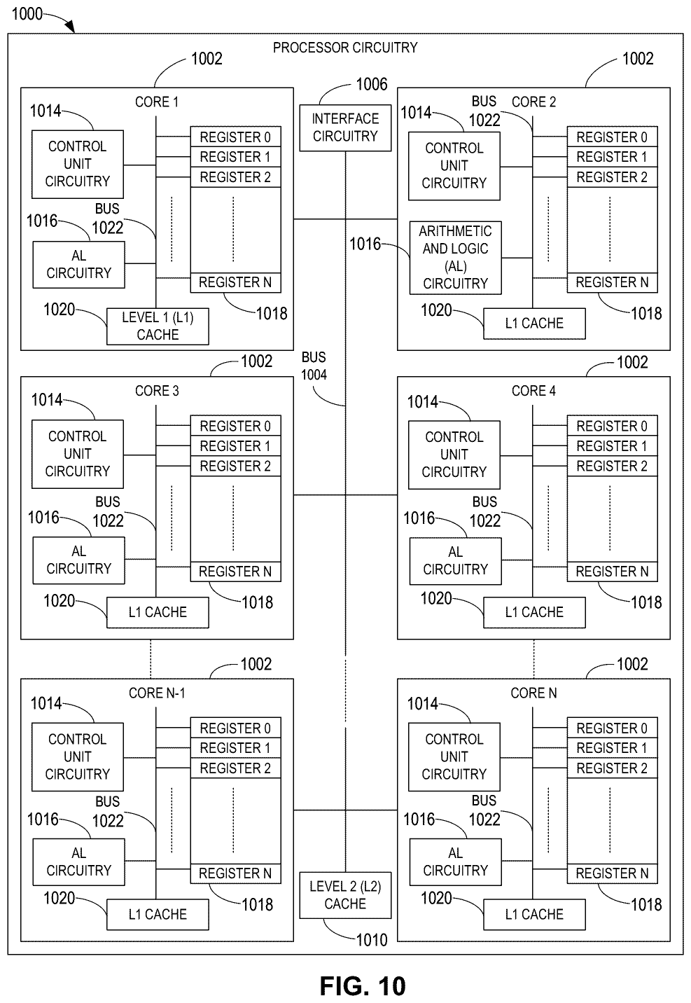

Flowchart(s) representative of example machine-readable instructions, which may be executed by programmable circuitry to implement and/or instantiate the deployed diffusion model 102, the training set generation circuitry 106 and the iteration selection model training circuitry 108 of FIGS. 1-4 and/or representative of example operations which may be performed by programmable circuitry to implement and/or instantiate the deployed diffusion model 102, the training set generation circuitry 106 and the iteration selection model training circuitry 108 of FIGS. 1-4, is shown in FIGS. 5-7. The machine-readable instructions may be one or more executable programs or portion(s) of one or more executable programs for execution by programmable circuitry such as the programmable circuitry 812, 912 shown in the example processor platform 800, 900 discussed below in connection with FIGS. 8 and/or 9 and/or may be one or more function(s) or portion(s) of functions to be performed by the example programmable circuitry (e.g., an FPGA) discussed below in connection with FIGS. 10 and/or 11. In some examples, the machine-readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine-readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine-readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 5-7, many other methods of implementing the trained iteration selection model 103, the training set generation circuitry 106 and the iteration selection model training circuitry 108 of FIGS. 1-4 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine-readable instructions described herein may be stored in one or more of a compressed format, an encrypted format, a fragmented format, a compiled format, an executable format, a packaged format, etc. Machine-readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine-readable instructions may be fragmented and stored on one or more storage devices, disks and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine-readable, computer-readable, and/or machine-readable media, as used herein, may include instructions and/or program(s) regardless of the particular format or state of the machine-readable instructions and/or program(s).

The machine-readable instructions described herein can be represented by any past, present, or future instruction language, scripting language, programming language, etc. For example, the machine-readable instructions may be represented using any of the following languages: C, C++, Java, C#, Perl, Python, JavaScript, HyperText Markup Language (HTML), Structured Query Language (SQL), Swift, Go Lang, etc.

As mentioned above, the example operations of FIG. 3 may be implemented using executable instructions (e.g., computer readable and/or machine-readable instructions) stored on one or more non-transitory computer readable and/or machine-readable media. As used herein, the terms non-transitory computer readable medium, non-transitory computer readable storage medium, non-transitory machine-readable medium, and/or non-transitory machine-readable storage medium are expressly defined to include any type of computer readable storage device and/or storage disk and to exclude propagating signals and to exclude transmission media. Examples of such non-transitory computer readable medium, non-transitory computer readable storage medium, non-transitory machine-readable medium, and/or non-transitory machine-readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine-readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine-readable instructions, etc., and/or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or operations, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or operations, the phrase “at least one of A or B” is intended to refer to implementations including any of (1) at least one A, (2) at least one B, or (3) at least one A and at least one B.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

Descriptors “first,” “second,” “third,” etc. are used herein when identifying multiple elements or components which may be referred to separately. Unless otherwise specified or understood based on their context of use, such descriptors are not intended to impute any meaning of priority or ordering in time but merely as labels for referring to multiple elements or components separately for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for ease of referencing multiple elements or components.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

FIG. 5 is a flowchart representative of example machine-readable instructions and/or example operations 500 that may be executed, instantiated, and/or performed by programmable circuitry(ies) to generate training data to train an iteration selection model. For example, the example operations 500 may be executed, instantiated, and/or performed by the training set generation circuitry 106 of FIG. 3. The example machine-readable instructions and/or the example operations 500 of FIG. 5 begin at block 502, at which the interface circuitry 300 applied a prompt to the diffusion model 302. The interface circuitry 300 may obtain the prompt from a user (e.g., via a user interface), from storage, or from another device. As described above, when the prompt is applied to the deployed diffusion model 102, the deployed diffusion model 102 outputs multiple outputs based on the prompt, the multiple outputs corresponding to multiple different denoising iterations.

At block 504, the comparator circuitry 304 obtains the outputs of the diffusion model 302 at N different denoising iterations. At block 506, the comparator circuitry 304 selects the first output at the lowest number of denoising iterations generated by the diffusion model 302. At block 508, the comparator circuitry selects the second output at the next lowest number of denoising iterations of the diffusion model 302. At block 510, the comparator circuitry 304 determines the similarity between the first output and the second output. For example, the comparator circuitry 304 may determine a SSIM based on the first output and the second output.

At block 512, if the similarity is the first determined similarity (block 512: YES), control continues to block 518. If the similarity is not the first determined similarity (e.g., a previous similarity between two outputs was previously determined) (block 512: NO), the comparator circuitry 304 compares the determined similarity to the previously determined similarity (block 514). For example, if the comparator circuitry 304 determines the similarity between a fourth output with 40 denoising iterations and a fifth output with 50 denoising iterations at block 510, then at block 510, the comparator circuitry 304 will compare the similarity between the fourth output and the fifth output to a third output with 30 denoising iterations and the fourth output with 40 denoising iterations at block 514.

At block 516, the comparator circuitry 304 determines if the determined similarity to the previously determined similarity has decreased. If the comparator circuitry 304 determines that the previously determined similarity has decreased (block 516: YES), control continues to block 522, as further described below. If the comparator circuitry 304 determines that the previously determined similarity has not decreased (block 516: NO), the comparator circuitry 304 replaces the first output with the second output (block 518) and selects a second output to be a subsequent output of the diffusion model 302 (block 520) and control returns to block 510 for a subsequent comparison. For example, if during the current iteration, the first output was the output with 40 denoising iterations and the second output was the output with 50 denoising iterations, the comparator circuitry 304 will change the first output to be the output with 50 denoising iterations and change the second output to be an output with 60 denoising iterations and control returns to block 510 for a subsequent comparison. If there are no more subsequent outputs left, the iteration determination circuitry 306 will select the highest number of denoising iterations as the target number of denoising iterations for the prompt.

As described above, if the comparator circuitry 304 determines that the similarity between subsequent comparisons has decreased (block 516: NO), control continues to block 522. As block 522, the iteration determination circuitry 306 stores the prompt in association with (e.g., labelled with) the target number of denoising iterations associated with the first output (e.g., the lower of the denoising iterations associated with the first and second output in the last comparison) into the database 308. As described above, the prompt associated with the target number of denoising iterations is stored as training data to train an iteration selection model.

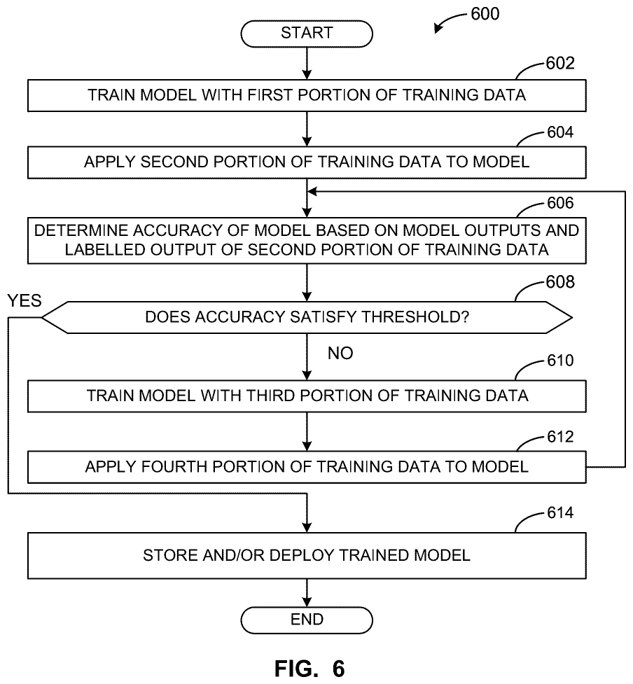

FIG. 6 is a flowchart representative of example machine-readable instructions and/or example operations 600 that may be executed, instantiated, and/or performed by programmable circuitry(ies) to train the trained iteration selection model 103 of FIG. 1. For example, the example operations 600 may be executed, instantiated, and/or performed by the iteration selection model training circuitry 108 of FIG. 4. The example machine-readable instructions and/or the example operations 600 of FIG. 6 begin at block 602, at which the training data application circuitry 402 trains the iteration selection model 406 with a first portion of the training data. For example, the training data application circuitry 402 may utilize the first portion of the training data with backpropagation to adjust the weights and/or threshold of the iteration selection model 406. The interface circuitry 400 obtains the training data from the database 308 of FIG. 3. The training data includes prompts that are labelled with a target number of denoising iterations.

At block 604, the model evaluation circuitry 404 applies a second portion of the training data (e.g., the prompts from the second portion of the training data) to the iteration selection model 406. At block 606, the model evaluation circuitry 404 determines the accuracy of the iteration selection model 406 based on the outputs of the iteration selection model 406 and the labelled outputs of the second portion of the training data. For example, if an output of the iteration selection model 406 for a prompt matches the labelled prompt, the model evaluation circuitry 404 determines that the iteration selection model was accurate. Otherwise, the model evaluation circuitry 404 determines that the iteration selection model was inaccurate. The model evaluation circuitry 404 determines the total accuracy based on the number of accurate and/or inaccurate outputs of the iteration selection model 406 for the second portion of the training data.

At block 608, the model evaluation circuitry 404 determines if the accuracy satisfies a threshold. If the model evaluation circuitry 404 determines that the accuracy satisfies a threshold (block 608: YES), control continues to block 614, as further described below. If the model evaluation circuitry 404 determines that the accuracy does not satisfy a threshold (block 608: NO), the training data application circuitry 402 trains the iteration selection model 406 with a third portion of the training data (block 610). At block 612, the model evaluation circuitry 404 applies a fourth portion of the training data (e.g., the prompts of the fourth portion of the training data) to the iteration selection model and control returns to block 606 until the accuracy of the iteration selection model 406 satisfies the threshold. At block 614, the model evaluation circuitry 404 outputs data corresponding to implementation of the trained model (e.g., the weights, thresholds, etc.) to the interface circuitry 400 to be stored and/or deployed to the deployed diffusion model 102.

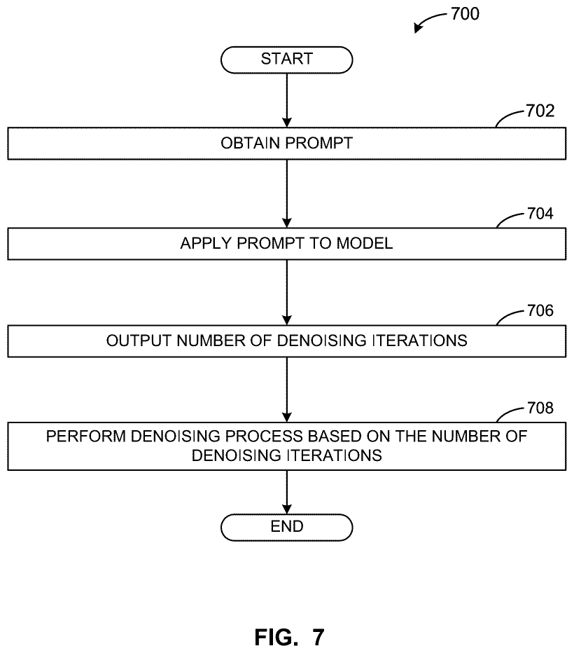

FIG. 7 is a flowchart representative of example machine-readable instructions and/or example operations 700 that may be executed, instantiated, and/or performed by determine a target number of denoising iterations to apply during a diffusion process based on a prompt. For example, the example operations 700 may be executed, instantiated, and/or performed by the deployed diffusion model 102 of FIGS. 1 and/or 2. The example machine-readable instructions and/or the example operations 700 of FIG. 7 begin at block 702, at which the trained iteration selection model 103 obtains a prompt. As described above, the prompt may be a text prompt from a user with instructions to generate an output image, video, sound, etc.

At block 704, the prompt is applied to the trained iteration selection model 103. As described above, the trained iteration selection model 103 generates a target number of denoising iterations to apply in a diffusion process based on the prompt. Accordingly, applying the prompt to the trained iteration selection model will result in an output target number of denoising iterations to perform in a diffusion process for the prompt. At block 706, the trained iteration selection model 103 outputs the target number of denoising iterations generated by the trained iteration selection model to the U-NET model circuitry 210 of FIG. 2. At block 708, the deployed diffusion model 102 performs the denoising process based on the prompt using the target number of denoising iterations, as further described above in conjunction with FIG. 2.

FIG. 8 is a block diagram of an example programmable circuitry platform 800 structured to execute and/or instantiate the example machine-readable instructions and/or the example operations of FIGS. 5-6 to implement the training set generation circuitry 106 and/or the iteration selection model training circuitry 108 of FIGS. 3-4. The programmable circuitry platform 800 can be, for example, a server, a personal computer, a workstation, a self-learning machine (e.g., a neural network), or any other type of computing and/or electronic device.

The programmable circuitry platform 800 of the illustrated example includes programmable circuitry 812. The programmable circuitry 812 of the illustrated example is hardware. For example, the programmable circuitry 812 can be implemented by one or more integrated circuits, logic circuits, FPGAs, microprocessors, CPUs, GPUs, DSPs, and/or microcontrollers from any desired family or manufacturer. The programmable circuitry 812 may be implemented by one or more semiconductor based (e.g., silicon based) devices. In this example, the programmable circuitry 812 implements the interface circuitry 300, the diffusion model 302, the comparator circuitry 304, the iteration determination circuitry 306, the interface circuitry 400, the training data application circuitry 402, the model evaluation circuitry 404, and the iteration selection model 406 of FIGS. 3-4.

The programmable circuitry 812 of the illustrated example includes a local memory 813 (e.g., a cache, registers, etc.). The programmable circuitry 812 of the illustrated example is in communication with main memory 814, 816, which includes a volatile memory 814 and a non-volatile memory 816, by a bus 818. The volatile memory 814 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 816 may be implemented by flash memory and/or any other desired type of memory device. Access to the main memory 814, 816 of the illustrated example is controlled by a memory controller 817. In some examples, the memory controller 817 may be implemented by one or more integrated circuits, logic circuits, microcontrollers from any desired family or manufacturer, or any other type of circuitry to manage the flow of data going to and from the main memory 814, 816. In some examples, any one or more of the local memory 813 and/or the main memory 814, 816 could implement the database 308 of FIG. 3.

The programmable circuitry platform 800 of the illustrated example also includes interface circuitry 820. The interface circuitry 820 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 822 are connected to the interface circuitry 820. The input device(s) 822 permit(s) a user (e.g., a human user, a machine user, etc.) to enter data and/or commands into the programmable circuitry 812. The input device(s) 822 can be implemented by, for example, a keyboard, a button, a mouse, and/or a touchscreen.

One or more output devices 824 are also connected to the interface circuitry 820 of the illustrated example. The output device(s) 824 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), and/or speaker. The interface circuitry 820 of the illustrated example, thus, typically includes a graphics driver card, a graphics driver chip, and/or graphics processor circuitry such as a GPU.

The interface circuitry 820 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 826. The communication can be by, for example, an Ethernet connection, a digital subscriber line (DSL) connection, a telephone line connection, a coaxial cable system, an optical fiber connection, a satellite system, a beyond-line-of-sight wireless system, a line-of-sight wireless system, a cellular telephone system, an optical connection, etc.

The programmable circuitry platform 800 of the illustrated example also includes one or more mass storage discs or devices 828 to store firmware, software, and/or data. Examples of such mass storage discs or devices 828 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine-readable instructions 832, which may be implemented by the machine-readable instructions of FIGS. 5-6, may be stored in the mass storage device 828, in the volatile memory 814, in the non-volatile memory 816, and/or on at least one non-transitory computer readable storage medium such as a CD or DVD which may be removable.

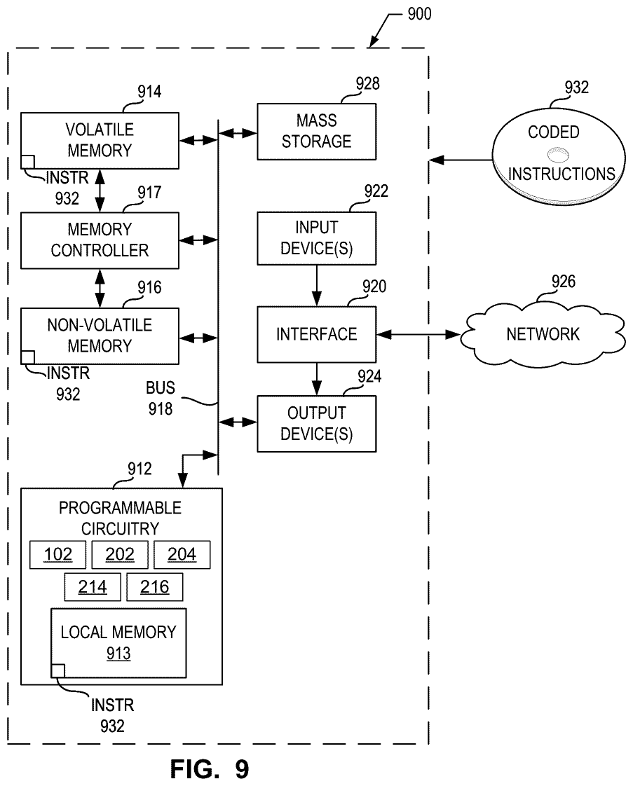

FIG. 9 is a block diagram of an example programmable circuitry platform 900 structured to execute and/or instantiate the example machine-readable instructions and/or the example operations of FIG. 7 to the deployed diffusion model 102 of FIG. 2. The programmable circuitry platform 900 can be, for example, a server, a personal computer, a workstation, a self-learning machine (e.g., a neural network), or any other type of computing and/or electronic device.

The programmable circuitry platform 900 of the illustrated example includes programmable circuitry 912. The programmable circuitry 912 of the illustrated example is hardware. For example, the programmable circuitry 912 can be implemented by one or more integrated circuits, logic circuits, FPGAs, microprocessors, CPUs, GPUs, DSPs, and/or microcontrollers from any desired family or manufacturer. The programmable circuitry 912 may be implemented by one or more semiconductor based (e.g., silicon based) devices. In this example, the programmable circuitry 912 implements the trained iteration selection model 103, the CLIP model circuitry 202, the U-NET model circuitry 210, the scheduler algorithm circuitry 214, and the VAE decoder circuitry 216 of FIG. 2.

The programmable circuitry 912 of the illustrated example includes a local memory 913 (e.g., a cache, registers, etc.). The programmable circuitry 912 of the illustrated example is in communication with main memory 914, 916, which includes a volatile memory 914 and a non-volatile memory 916, by a bus 918. The volatile memory 914 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 916 may be implemented by flash memory and/or any other desired type of memory device. Access to the main memory 914, 916 of the illustrated example is controlled by a memory controller 917. In some examples, the memory controller 917 may be implemented by one or more integrated circuits, logic circuits, microcontrollers from any desired family or manufacturer, or any other type of circuitry to manage the flow of data going to and from the main memory 914, 916.

The programmable circuitry platform 900 of the illustrated example also includes interface circuitry 920. The interface circuitry 920 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 922 are connected to the interface circuitry 920. The input device(s) 922 permit(s) a user (e.g., a human user, a machine user, etc.) to enter data and/or commands into the programmable circuitry 912. The input device(s) 922 can be implemented by, for example, a keyboard, a button, a mouse, and/or a touchscreen.

One or more output devices 924 are also connected to the interface circuitry 920 of the illustrated example. The output device(s) 924 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), and/or speaker. The interface circuitry 920 of the illustrated example, thus, typically includes a graphics driver card, a graphics driver chip, and/or graphics processor circuitry such as a GPU.

The interface circuitry 920 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 926. The communication can be by, for example, an Ethernet connection, a digital subscriber line (DSL) connection, a telephone line connection, a coaxial cable system, an optical fiber connection, a satellite system, a beyond-line-of-sight wireless system, a line-of-sight wireless system, a cellular telephone system, an optical connection, etc.

The programmable circuitry platform 900 of the illustrated example also includes one or more mass storage discs or devices 928 to store firmware, software, and/or data. Examples of such mass storage discs or devices 928 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine-readable instructions 932, which may be implemented by the machine-readable instructions of FIG. 7, may be stored in the mass storage device 928, in the volatile memory 914, in the non-volatile memory 916, and/or on at least one non-transitory computer readable storage medium such as a CD or DVD which may be removable.

FIG. 10 is a block diagram of an example implementation of the programmable circuitry 812, 912 of FIGS. 8 and/or 9. In this example, the programmable circuitry 812, 912 of FIGS. 8 and/or 9 is implemented by a microprocessor 1000. For example, the microprocessor 1000 may be a general-purpose microprocessor (e.g., general-purpose microprocessor circuitry). The microprocessor 1000 executes some or all of the machine-readable instructions of the flowcharts of FIGS. 5-7 to effectively instantiate the circuitry of FIGS. 1, 2, 3 and/or 4 as logic circuits to perform operations corresponding to those machine-readable instructions. In some such examples, the circuitry of FIGS. 1, 2, 3 and/or 4 is instantiated by the hardware circuits of the microprocessor 1000 in combination with the machine-readable instructions. For example, the microprocessor 1000 may be implemented by multi-core hardware circuitry such as a CPU, a DSP, a GPU, an XPU, etc. Although it may include any number of example cores 1002 (e.g., 1 core), the microprocessor 1000 of this example is a multi-core semiconductor device including N cores. The cores 1002 of the microprocessor 1000 may operate independently or may cooperate to execute machine-readable instructions. For example, machine code corresponding to a firmware program, an embedded software program, or a software program may be executed by one of the cores 1002 or may be executed by multiple ones of the cores 1002 at the same or different times. In some examples, the machine code corresponding to the firmware program, the embedded software program, or the software program is split into threads and executed in parallel by two or more of the cores 1002. The software program may correspond to a portion or all of the machine-readable instructions and/or operations represented by the flowchart of FIG. 3.

The cores 1002 may communicate by a first example bus 1004.

In some examples, the first bus 1004 may be implemented by a communication bus to effectuate communication associated with one(s) of the cores 1002. For example, the first bus 1004 may be implemented by at least one of an Inter-Integrated Circuit (I2C) bus, a Serial Peripheral Interface (SPI) bus, a PCI bus, or a PCIe bus. Additionally or alternatively, the first bus 1004 may be implemented by any other type of computing or electrical bus. The cores 1002 may obtain data, instructions, and/or signals from one or more external devices by example interface circuitry 1006. The cores 1002 may output data, instructions, and/or signals to the one or more external devices by the interface circuitry 1006. Although the cores 1002 of this example include example local memory 1020 (e.g., Level 1 (L1) cache that may be split into an L1 data cache and an L1 instruction cache), the microprocessor 1000 also includes example shared memory 1010 that may be shared by the cores (e.g., Level 2 (L2 cache)) for high-speed access to data and/or instructions. However, in some examples the L2 cache is connected to each core 1002 and the shared memory 1010 is implemented by level 3 (L3) cache for high-speed access to data and/or instructions. Data and/or instructions may be transferred (e.g., shared) by writing to and/or reading from the shared memory 1010. The local memory 1020 of each of the cores 1002 and the shared memory 1010 may be part of a hierarchy of storage devices including multiple levels of cache memory and the main memory (e.g., the main memory 814, 816, 914, 916 of FIGS. 8 and/or 9). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1002 may be referred to as a CPU, DSP, GPU, etc., or any other type of hardware circuitry. Each core 1002 includes control unit circuitry 1014, arithmetic and logic (AL) circuitry (sometimes referred to as an ALU) 1016, a plurality of registers 1018, the local memory 1020, and a second example bus 1022. Other structures may be present. For example, each core 1002 may include vector unit circuitry, single instruction multiple data (SIMD) unit circuitry, load/store unit (LSU) circuitry, branch/jump unit circuitry, floating-point unit (FPU) circuitry, etc. The control unit circuitry 1014 includes semiconductor-based circuits structured to control (e.g., coordinate) data movement within the corresponding core 1002. The AL circuitry 1016 includes semiconductor-based circuits structured to perform one or more mathematic and/or logic operations on the data within the corresponding core 1002. The AL circuitry 1016 of some examples performs integer-based operations. In other examples, the AL circuitry 1016 also performs floating-point operations. In yet other examples, the AL circuitry 1016 may include first AL circuitry that performs integer-based operations and second AL circuitry that performs floating-point operations. In some examples, the AL circuitry 1016 may be referred to as an Arithmetic Logic Unit (ALU).

The registers 1018 are semiconductor-based structures to store data and/or instructions such as results of one or more of the operations performed by the AL circuitry 1016 of the corresponding core 1002. For example, the registers 1018 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1018 may be arranged in a bank as shown in FIG. 10. Alternatively, the registers 1018 may be organized in any other arrangement, format, or structure, such as by being distributed throughout the core 1002 to shorten access time. The second bus 1022 may be implemented by at least one of an I2C bus, a SPI bus, a PCI bus, or a PCIe bus.

Each core 1002 and/or, more generally, the microprocessor 1000 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1000 is a semiconductor device fabricated to include many transistors interconnected to implement the structures described above in one or more integrated circuits (ICs) contained in one or more packages.

The microprocessor 1000 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1000, in the same chip package as the microprocessor 1000 and/or in one or more separate packages from the microprocessor 1000.

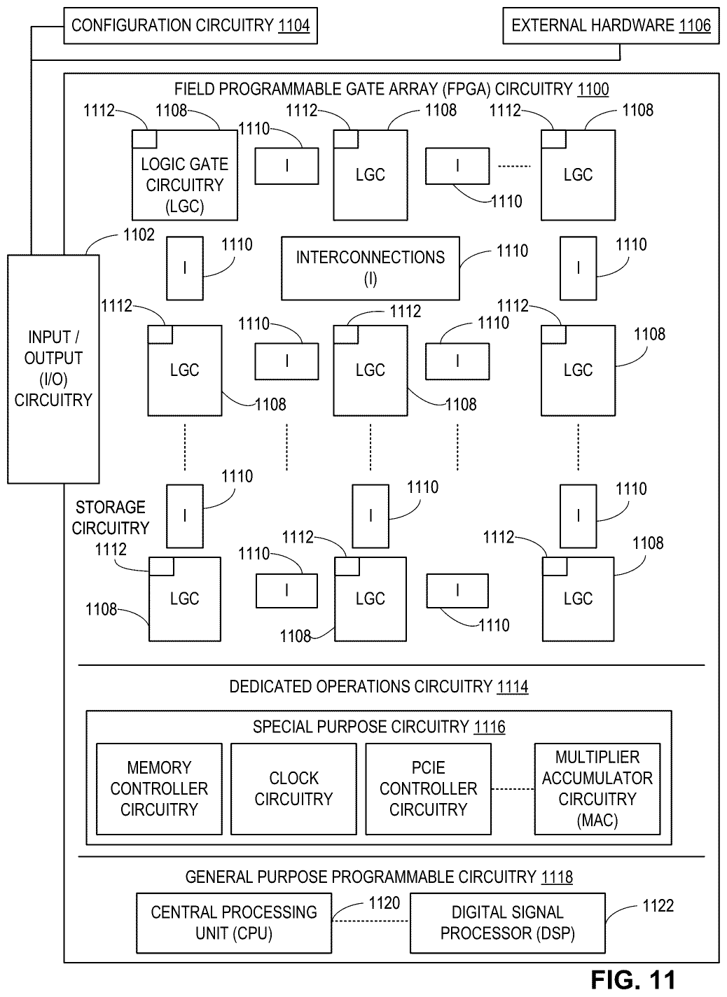

FIG. 11 is a block diagram of another example implementation of the programmable circuitry 1112 of FIG. 11. In this example, the programmable circuitry 812, 912 is implemented by FPGA circuitry 1100. For example, the FPGA circuitry 1100 may be implemented by an FPGA. The FPGA circuitry 1100 can be used, for example, to perform operations that could otherwise be performed by the example microprocessor 1000 of FIG. 10 executing corresponding machine-readable instructions. However, once configured, the FPGA circuitry 1100 instantiates the operations and/or functions corresponding to the machine-readable instructions in hardware and, thus, can often execute the operations/functions faster than they could be performed by a general-purpose microprocessor executing the corresponding software.

More specifically, in contrast to the microprocessor 1000 of FIG. 10 described above (which is a general purpose device that may be programmed to execute some or all of the machine-readable instructions represented by the flowchart(s) of FIGS. 5-7 but whose interconnections and logic circuitry are fixed once fabricated), the FPGA circuitry 1100 of the example of FIG. 11 includes interconnections and logic circuitry that may be configured, structured, programmed, and/or interconnected in different ways after fabrication to instantiate, for example, some or all of the operations/functions corresponding to the machine-readable instructions represented by the flowchart(s) of FIGS. 5-7. In particular, the FPGA circuitry 1100 may be thought of as an array of logic gates, interconnections, and switches. The switches can be programmed to change how the logic gates are interconnected by the interconnections, effectively forming one or more dedicated logic circuits (unless and until the FPGA circuitry 1100 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 5-7. As such, the FPGA circuitry 1100 may be configured and/or structured to effectively instantiate some or all of the operations/functions corresponding to the machine-readable instructions of the flowchart(s) of FIGS. 5-7 as dedicated logic circuits to perform the operations/functions corresponding to those software instructions in a dedicated manner analogous to an ASIC. Therefore, the FPGA circuitry 1100 may perform the operations/functions corresponding to the some or all of the machine-readable instructions of FIGS. 5-7 faster than the general-purpose microprocessor can execute the same.

In the example of FIG. 11, the FPGA circuitry 1100 is configured and/or structured in response to being programmed (and/or reprogrammed one or more times) based on a binary file. In some examples, the binary file may be compiled and/or generated based on instructions in a hardware description language (HDL) such as Lucid, Very High-Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1100 of FIG. 11 may access and/or load the binary file to cause the FPGA circuitry 1100 of FIG. 11 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1100 of FIG. 11 to cause configuration and/or structuring of the FPGA circuitry 1100 of FIG. 11, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1100 of FIG. 11 may access and/or load the binary file to cause the FPGA circuitry 1100 of FIG. 11 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1100 of FIG. 11 to cause configuration and/or structuring of the FPGA circuitry 1100 of FIG. 11, or portion(s) thereof.

The FPGA circuitry 1100 of FIG. 11, includes example input/output (I/O) circuitry 1102 to obtain and/or output data to/from example configuration circuitry 1104 and/or external hardware 1106. For example, the configuration circuitry 1104 may be implemented by interface circuitry that may obtain a binary file, which may be implemented by a bit stream, data, and/or machine-readable instructions, to configure the FPGA circuitry 1100, or portion(s) thereof. In some such examples, the configuration circuitry 1104 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1106 may be implemented by external hardware circuitry. For example, the external hardware 1106 may be implemented by the microprocessor 1000 of FIG. 10.

The FPGA circuitry 1100 also includes an array of example logic gate circuitry 1108, a plurality of example configurable interconnections 1110, and example storage circuitry 1112. The logic gate circuitry 1108 and the configurable interconnections 1110 are configurable to instantiate one or more operations/functions that may correspond to at least some of the machine-readable instructions of FIGS. 5-7 and/or other desired operations. The logic gate circuitry 1108 shown in FIG. 11 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1108 to enable configuration of the electrical structures and/or the logic gates to form circuits to perform desired operations/functions. The logic gate circuitry 1108 may include other electrical structures such as look-up tables (LUTs), registers (e.g., flip-flops or latches), multiplexers, etc.

The configurable interconnections 1110 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1108 to program desired logic circuits.

The storage circuitry 1112 of the illustrated example is structured to store result(s) of the one or more of the operations performed by corresponding logic gates. The storage circuitry 1112 may be implemented by registers or the like. In the illustrated example, the storage circuitry 1112 is distributed amongst the logic gate circuitry 1108 to facilitate access and increase execution speed.

The example FPGA circuitry 1100 of FIG. 11 also includes example dedicated operations circuitry 1114. In this example, the dedicated operations circuitry 1114 includes special purpose circuitry 1116 that may be invoked to implement commonly used functions to avoid the need to program those functions in the field. Examples of such special purpose circuitry 1116 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1100 may also include example general purpose programmable circuitry 1118 such as an example CPU 1120 and/or an example DSP 1122. Other general purpose programmable circuitry 1118 may additionally or alternatively be present such as a GPU, an XPU, etc., that can be programmed to perform other operations.

Although FIGS. 10 and 11 illustrate two example implementations of the programmable circuitry 812, 912 of FIGS. 8 and/or 9, many other approaches are contemplated. For example, FPGA circuitry may include an on-board CPU, such as one or more of the example CPU 1120 of FIG. 10. Therefore, the programmable circuitry 812, 912 of FIGS. 8 and/or 9 may additionally be implemented by combining at least the example microprocessor 1000 of FIG. 10 and the example FPGA circuitry 1100 of FIG. 11. In some such hybrid examples, one or more cores 1002 of FIG. 10 may execute a first portion of the machine-readable instructions represented by the flowchart(s) of FIGS. 5-7 to perform first operation(s)/function(s), the FPGA circuitry 1100 of FIG. 11 may be configured and/or structured to perform second operation(s)/function(s) corresponding to a second portion of the machine-readable instructions represented by the flowcharts of FIGS. 5-7, and/or an ASIC may be configured and/or structured to perform third operation(s)/function(s) corresponding to a third portion of the machine-readable instructions represented by the flowcharts of FIGS. 5-7.

It should be understood that some or all of the circuitry of FIGS. 10 and/or 11 may, thus, be instantiated at the same or different times. For example, the same and/or different portion(s) of the microprocessor 1000 of FIG. 10 may be programmed to execute portion(s) of machine-readable instructions at the same and/or different times. In some examples, same and/or different portion(s) of the FPGA circuitry 1100 of FIG. 11 may be configured and/or structured to perform operations/functions corresponding to portion(s) of machine-readable instructions at the same and/or different times.

In some examples, some or all of the circuitry of FIGS. 10 and/or 11 may be instantiated, for example, in one or more threads executing concurrently and/or in series. For example, the microprocessor 1000 of FIG. 10 may execute machine-readable instructions in one or more threads executing concurrently and/or in series. In some examples, the FPGA circuitry 1100 of FIG. 11 may be configured and/or structured to carry out operations/functions concurrently and/or in series. Moreover, in some examples, some or all of the processor circuitry 1000, 1100 of FIGS. 10 and/or 11 may be implemented within one or more virtual machines and/or virtual execution environments executing on the microprocessor 1000 of FIG. 10.

In some examples, the programmable circuitry 812, 912 of FIGS. 8 and/or 9 may be in one or more packages. For example, the microprocessor 1000 of FIG. 10 and/or the FPGA circuitry 1100 of FIG. 11 may be in one or more packages. In some examples, an XPU may be implemented by the programmable circuitry 812, 912 of FIGS. 8 and/or 9, which may be in one or more packages. For example, the XPU may include a CPU (e.g., the microprocessor 1000 of FIG. 10, the CPU 1120 of FIG. 11, etc.) in one package, a DSP (e.g., the DSP 1122 of FIG. 11) in another package, a GPU in yet another package, and an FPGA (e.g., the FPGA circuitry 1100 of FIG. 11) in still yet another package.

Example methods, apparatus, systems, and articles of manufacture to determine a number of denoising iterations of model output generation are disclosed herein. Further examples and combinations thereof include the following: Example 1 includes an electronic device comprising interface circuitry to receive a text-based prompt to generate an image, instructions, at least one programmable circuit to be programmed by the instructions to execute a model to generate a plurality of outputs based on the text-based prompt, each of the plurality of outputs generated using different numbers of denoising iterations, generate an ordered set of the plurality of outputs based on the number of denoising iterations, determine a plurality of similarities between neighboring outputs in the ordered set of the plurality of outputs, and select a target number of denoising iterations based on the plurality of similarities.

Example 2 includes the electronic device of example 1, wherein the at least one programmable circuit is to store the text-based prompt in conjunction with the target number of denoising iterations as training data.

Example 3 includes the electronic device of example 2, wherein the at least one programmable circuit is to train an artificial intelligence-based model using the training data, the artificial intelligence-based model trained to output a target number of denoising iterations based on an input prompt.

Example 4 includes the electronic device of example 1, wherein the at least one programmable circuit is to select the target number of denoising iterations based on a similarity between a first output of the plurality of outputs and a second output of the plurality of outputs.

Example 5 includes the electronic device of example 1, wherein the at least one programmable circuit is to select the target number of denoising iterations based on a first similarity between a first and second output of the plurality of outputs being less than a second similarity between the second output and a third output of the plurality of outputs.

Example 6 includes the electronic device of example 5, wherein a first number of denoising iterations corresponding to the third output is less than a second number of denoising iterations corresponding to the first output.

Example 7 includes the electronic device of example 1, wherein the at least one programmable circuit is to select the target number of denoising iterations by determining a first similarity metric based on a first similarity between a first one of the plurality of outputs and a second one of the plurality of outputs, the first one of the plurality of outputs generated using less denoising iterations that the second one of the plurality of outputs, determining a second similarity metric based on a second similarity between the second one of the plurality of outputs and a third one of the plurality of outputs, the third one of the plurality of outputs generated using more denoising iterations that the second one of the plurality of outputs, and selecting the target number of denoising iterations corresponding to the second one of the plurality of outputs based on the second similarity metric being less than the first similarity metric.

Example 8 includes the electronic device of example 1, wherein the model is a diffusion model.

Example 9 includes a non-transitory computer readable medium comprising instructions to cause at least one programmable circuit to at least execute a model to generate a plurality of outputs based on a text-based prompt, each of the plurality of outputs generated using different numbers of denoising iterations, generate an ordered set of the plurality of outputs based on the number of denoising iterations, determine a plurality of similarities between neighboring outputs in the ordered set of the plurality of outputs, and select a target number of denoising iterations based on the plurality of similarities.

Example 10 includes the non-transitory computer readable medium of example 9, wherein the instructions cause the at least one programmable circuit to store the text-based prompt in conjunction with the target number of denoising iterations as training data.

Example 11 includes the non-transitory computer readable medium of example 10, wherein the instructions cause the at least one programmable circuit to train an artificial intelligence-based model using the training data, the artificial intelligence-based model trained to output a number of denoising iterations based on an input prompt.

Example 12 includes the non-transitory computer readable medium of example 9, wherein the instructions cause the at least one programmable circuit to select the target number of denoising iterations based on a similarity between a first output of the plurality of outputs and a second output of the plurality of outputs.

Example 13 includes the non-transitory computer readable medium of example 9, wherein the instructions cause the at least one programmable circuit to select the target number of denoising iterations based on a first similarity between a first and second output of the plurality of outputs being less than a second similarity between the second output and a third output of the plurality of outputs.

Example 14 includes the non-transitory computer readable medium of example 13, wherein a first number of denoising iterations corresponding to the third output is less than a second number of denoising iterations corresponding to the first output.

Example 15 includes the non-transitory computer readable medium of example 9, wherein the instructions cause the at least one programmable circuit to select the target number of denoising iterations by determining a first similarity metric based on a first similarity between a first one of the plurality of outputs and a second one of the plurality of outputs, the first one of the plurality of outputs generated using less denoising iterations that the second one of the plurality of outputs, determining a second similarity metric based on a second similarity between the second one of the plurality of outputs and a third one of the plurality of outputs, the third one of the plurality of outputs generated using more denoising iterations that the second one of the plurality of outputs, and selecting the target number of denoising iterations corresponding to the second one of the plurality of outputs based on the second similarity metric being less than the first similarity metric.

Example 16 includes the non-transitory computer readable medium of example 9, wherein the model is a diffusion model.

Example 17 includes a method comprising executing a model to generate a plurality of outputs based on a text-based prompt, each of the plurality of outputs generated using different numbers of denoising iterations, generating an ordered set of the plurality of outputs based on the number of denoising iterations, determining a plurality of similarities between neighboring outputs in the ordered set of the plurality of outputs, and selecting a target number of denoising iterations based on the plurality of similarities.

Example 18 includes the method of example 17, further including storing the text-based prompt in conjunction with the target number of denoising iterations as training data.

Example 19 includes the method of example 18, further including training an artificial intelligence-based model using the training data, the artificial intelligence-based model trained to output a number of denoising iterations based on an input prompt.

Example 20 includes the method of example 17, further including selecting the target number of denoising iterations based on a similarity between a first output of the plurality of outputs and a second output of the plurality of outputs.

Example 21 includes the method of example 17, further including selecting the target number of denoising iterations based on a first similarity between a first and second output of the plurality of outputs being less than a second similarity between the second output and a third output of the plurality of outputs.

Example 22 includes the method of example 21, wherein a first number of denoising iterations corresponding to the third output is less than a second number of denoising iterations corresponding to the first output.

Example 23 includes the method of example 17, further including selecting the target number of denoising iterations by determining a first similarity metric based on a first similarity between a first one of the plurality of outputs and a second one of the plurality of outputs, the first one of the plurality of outputs generated using less denoising iterations that the second one of the plurality of outputs, determining a second similarity metric based on a second similarity between the second one of the plurality of outputs and a third one of the plurality of outputs, the third one of the plurality of outputs generated using more denoising iterations that the second one of the plurality of outputs, and selecting the target number of denoising iterations corresponding to the second one of the plurality of outputs based on the second similarity metric being less than the first similarity metric.

Example 24 includes the method of example 17, wherein the model is a diffusion model.

Example 25 includes a non-transitory computer readable medium comprising instructions to cause at least one programmable circuit to at least apply a prompt to an artificial intelligence-based model to generate an output number of denoising iterations, the artificial intelligence-based model trained to output a target number of denoising iterations based on the prompt, wherein the prompt is a text-based prompt including instructions to generate an output image, and perform the target number of denoising iterations to generate the output image based on the prompt.

Example 26 includes the non-transitory computer readable medium of example 25, wherein instructions cause the at least one programmable circuit to perform a denoising iteration of the diffusion process by generating a conditioned latent by denoising an input latent while conditioning the input latent based on the prompt, the conditioned latent being a compressed representations of data corresponding to an image, the input latent being an input image in a latent space, and adding noise to the conditioned latent to generate a subsequent input latent to replace the input latent for a subsequent iteration.

Example 27 includes the non-transitory computer readable medium of example 26, wherein the instructions cause the at least one programmable circuit to, after the number of denoising iterations are complete, decode a final input latent generated during a final iteration to generate the output image.

From the foregoing, it will be appreciated that example systems, apparatus, articles of manufacture, and methods have been disclosed to determine a number of denoising iterations of model output generation. Examples disclosed herein conserve resources and generate a high-quality output by determine a number of denoising iterations to perform when performing a diffusion process that is based on the input prompt. Accordingly, instead of using a preset number of denoising iterations, which will over consume responses for some prompts, and produce a sub-par output for other prompts, examples disclosed herein varies the number of denoising iterations based on the prompt. Thus, the disclosed systems, apparatus, articles of manufacture, and methods are accordingly directed to one or more improvement(s) in the operation of a machine such as a computer or other electronic and/or mechanical device.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. An electronic device comprising:
interface circuitry to receive a text-based prompt to generate an image;
instructions;
at least one programmable circuit to be programmed by the instructions to:
execute a model to generate a plurality of outputs based on the text-based prompt, each of the plurality of outputs generated using different numbers of denoising iterations;
generate an ordered set of the plurality of outputs based on the number of denoising iterations;
determine a plurality of similarities between neighboring outputs in the ordered set of the plurality of outputs; and
select a target number of denoising iterations based on the plurality of similarities.

2. The electronic device of claim 1, wherein the at least one programmable circuit is to store the text-based prompt in conjunction with the target number of denoising iterations as training data.

3. The electronic device of claim 2, wherein the at least one programmable circuit is to train an artificial intelligence-based model using the training data, the artificial intelligence-based model trained to output a target number of denoising iterations based on an input prompt.

4. The electronic device of claim 1, wherein the at least one programmable circuit is to select the target number of denoising iterations based on a similarity between a first output of the plurality of outputs and a second output of the plurality of outputs.

5. The electronic device of claim 1, wherein the at least one programmable circuit is to select the target number of denoising iterations based on a first similarity between a first and second output of the plurality of outputs being less than a second similarity between the second output and a third output of the plurality of outputs.

6. The electronic device of claim 5, wherein a first number of denoising iterations corresponding to the third output is less than a second number of denoising iterations corresponding to the first output.

7. The electronic device of claim 1, wherein the at least one programmable circuit is to select the target number of denoising iterations by:
determining a first similarity metric based on a first similarity between a first one of the plurality of outputs and a second one of the plurality of outputs, the first one of the plurality of outputs generated using less denoising iterations that the second one of the plurality of outputs;
determining a second similarity metric based on a second similarity between the second one of the plurality of outputs and a third one of the plurality of outputs, the third one of the plurality of outputs generated using more denoising iterations that the second one of the plurality of outputs; and
selecting the target number of denoising iterations corresponding to the second one of the plurality of outputs based on the second similarity metric being less than the first similarity metric.

8. The electronic device of claim 1, wherein the model is a diffusion model.

9. A non-transitory computer readable medium comprising instructions to cause at least one programmable circuit to at least:
execute a model to generate a plurality of outputs based on a text-based prompt, each of the plurality of outputs generated using different numbers of denoising iterations;
generate an ordered set of the plurality of outputs based on the number of denoising iterations;
determine a plurality of similarities between neighboring outputs in the ordered set of the plurality of outputs; and
select a target number of denoising iterations based on the plurality of similarities.

10. The non-transitory computer readable medium of claim 9, wherein the instructions cause the at least one programmable circuit to store the text-based prompt in conjunction with the target number of denoising iterations as training data.

11. The non-transitory computer readable medium of claim 10, wherein the instructions cause the at least one programmable circuit to train an artificial intelligence-based model using the training data, the artificial intelligence-based model trained to output a number of denoising iterations based on an input prompt.

12. The non-transitory computer readable medium of claim 9, wherein the instructions cause the at least one programmable circuit to select the target number of denoising iterations based on a similarity between a first output of the plurality of outputs and a second output of the plurality of outputs.

13. The non-transitory computer readable medium of claim 9, wherein the instructions cause the at least one programmable circuit to select the target number of denoising iterations based on a first similarity between a first and second output of the plurality of outputs being less than a second similarity between the second output and a third output of the plurality of outputs.

14. The non-transitory computer readable medium of claim 13, wherein a first number of denoising iterations corresponding to the third output is less than a second number of denoising iterations corresponding to the first output.

15. The non-transitory computer readable medium of claim 9, wherein the instructions cause the at least one programmable circuit to select the target number of denoising iterations by:
determining a first similarity metric based on a first similarity between a first one of the plurality of outputs and a second one of the plurality of outputs, the first one of the plurality of outputs generated using less denoising iterations that the second one of the plurality of outputs;
determining a second similarity metric based on a second similarity between the second one of the plurality of outputs and a third one of the plurality of outputs, the third one of the plurality of outputs generated using more denoising iterations that the second one of the plurality of outputs; and
selecting the target number of denoising iterations corresponding to the second one of the plurality of outputs based on the second similarity metric being less than the first similarity metric.

16. The non-transitory computer readable medium of claim 9, wherein the model is a diffusion model.

17. A method comprising:
executing a model to generate a plurality of outputs based on a text-based prompt, each of the plurality of outputs generated using different numbers of denoising iterations;
generating an ordered set of the plurality of outputs based on the number of denoising iterations;
determining a plurality of similarities between neighboring outputs in the ordered set of the plurality of outputs; and
selecting a target number of denoising iterations based on the plurality of similarities.

18. The method of claim 17, further including storing the text-based prompt in conjunction with the target number of denoising iterations as training data.

19. The method of claim 18, further including training an artificial intelligence-based model using the training data, the artificial intelligence-based model trained to output a number of denoising iterations based on an input prompt.

20. The method of claim 17, further including selecting the target number of denoising iterations based on a similarity between a first output of the plurality of outputs and a second output of the plurality of outputs.
